(19) United States
(12) Patent Application Publication
(10) Pub. No.: US 2002/0170364 A1
(43) Pub. Date: Nov. 21, 2002

(54) Sampling of flammable liquefied gas

(76) Inventors: Visser Johan Gerard, Lochem (NL); Van Mierlo Martinus Johannes Albert, Deventer (NL)

Correspondence Address: Richard P. Fennelly, Akzo Nobel Inc. - Intellectual Property Department, 7 Livingstone Avenue, Dobbs Ferry, NY, 10522, US

(21) Appl. No.: 10/145,050

(22) Filed: May 14, 2002

Related U.S. Application Data
(60) Provisional application No. 60/291,473, filed on May 16, 2001.

(51) Int. Cl. G01N 1/00

(52) U.S. Cl. 73/863.86

(57) ABSTRACT

The invention relates to a sampling container for taking samples from a tank containing a flammable liquefied gas. The container comprises an inlet opening and an outlet opening, at least two valves for operating the openings, and a connector at the inlet opening for establishing fluid communication with the tank. A nozzle which communicates with the inlet opening and which suppresses the splashing of liquefied gas flowing into the sampling container and hence the build-up of static electricity. The invention further pertains to an apparatus for taking samples from a tank containing a flammable liquefied gas, comprising a first connector-counterpart for receiving the connector of the sampling container.

This application claims the benefit of U.S. Provisional Application Ser. No. 60/291,473, filed May 16, 2001.

The invention relates to a sampling container for taking samples from a tank containing a flammable liquefied gas. The container comprises an inlet opening and an outlet opening, at least two valves for operating the openings, and a connector at the inlet opening for establishing fluid communication with the tank. The invention further pertains to an apparatus for taking samples from a tank containing a flammable liquefied gas, comprising a first connector-counterpart for receiving the connector of the sampling container.

Various methods are used to take samples of liquefied gases that are stored in a tank-like container. Typically such a tank is equipped with a valve. In order to take samples from the tank, a flexible and/or rigid sampling line can be connected to said valve and to the bottom valve of a sampling container that is equipped with said bottom valve and a top valve.

For flammable liquefied gases that are stored in a tank, such conventional procedures were found to lead to unsafe situations. More particularly, disconnecting the sampling line can result in the undesired release of liquefied flammable gas from said line, which typically results in the presence of a large amount of flammable gas, with all associated hazards, such as asphyxiation of operators, formation of explosive and/or flammable vapour clouds, and the like. Therefore, sampling of flammable liquids is preferably kept to a minimum. However, on occasion, such sampling cannot be avoided. For example, in view of quality assurance programs it is often necessary to sample incoming goods for analysis and approval.

An apparatus and a method for taking samples from a tank containing e.g. liquefied n-butane, isobutane, propane or dimethylether, is known from German application DE 41 05 347. The apparatus and method according to this publication use a rotary depth gauge tube fifted to the tank. A sample is taken by (a) tightly connecting one or more pressure-tight sampling containers to the gauge tube valve; (b) flushing the container(s) with liquid from the pressure vessel; (c) filling the container(s) with sample liquid, and (d) removing the filled container(s). The sampling equipment includes (i) a pressure-tight line, preferably a hose, with a shut-off valve at each end; (ii) a connection element at one end of the line for pressure-tight connection to the gauge tube valve; and (iii) at least two further valves at the other end of the line for connection to one or more sampling containers.

It is noted that the transport, handling, and storage of (highly) flammable liquefied gases typically is regulated. Furthermore, liquefied dimethyl ether is an insulator with respect to electrical properties, just as single-chain hydrocarbons are. Handling of insulating liquids implies using stringent safety measures to prevent static electricity discharges, which may cause accidental ignition of dimethyl ether leakage. Insufficiently bonded and grounded metal parts of the equipment in contact with liquefied dimethyl ether can obtain a charge of equal but opposite polarity. Discharges of static electrical nature may proceed from accumulated charged dimethyl ether or isolated metal parts of the equipment, which are then oppositely charged, and can be of sufficient strength to ignite a flammable mixture.

It is an object of the present invention to provide an improved sampling container and apparatus for taking samples from a container comprising a flammable liquefied gas.

This object is achieved by means of the sampling container and apparatus according to respectively claims 1 and 6, which were found to be pre-eminently suited for taking samples of a flammable liquefied gas which is prone to the buildup of static electricity, such as dimethyl ether, propane and/or butane. Preferably, the system is used to sample liquefied gases for use as an aerosol.

The term “flammable liquefied gases” as used throughout this document is meant to denominate all liquefied gases of which the material safety data sheet lists R-phrase 16 and/or 38. Flammable liquefied gases that are prone to static electricity build-up are considered to be liquefied gases of which the material safety data sheet (also) lists R-phrase 33. The invention is not limited to systems and/or procedures wherein just one liquefied gas is present. Any mixture containing at least one flammable liquefied gas can be sampled according to the present invention.

The invention will now be explained in more detail with reference to the drawings, in which a preferred apparatus according to the invention is schematically shown.

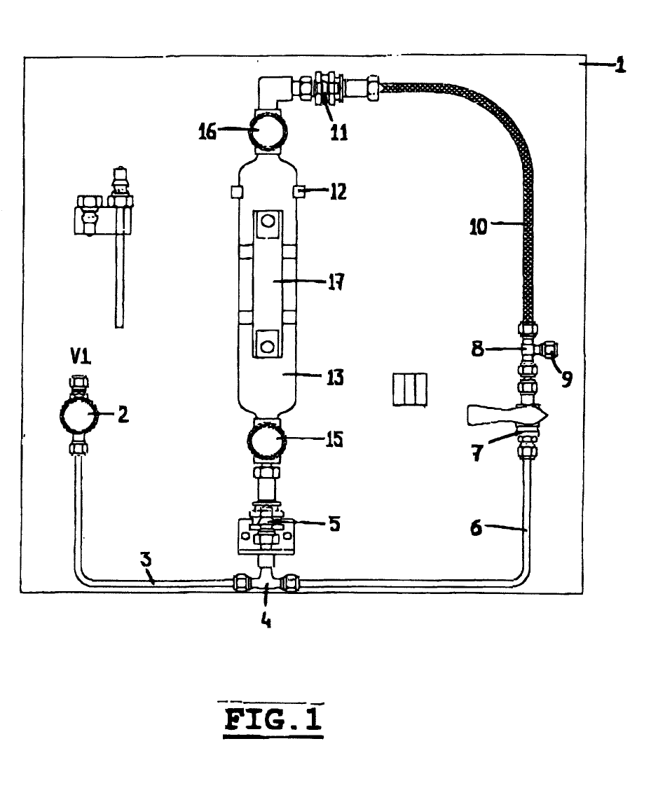

FIG. 1 shows an apparatus according to the present invention for taking samples from a tank containing a flammable liquefied gas.

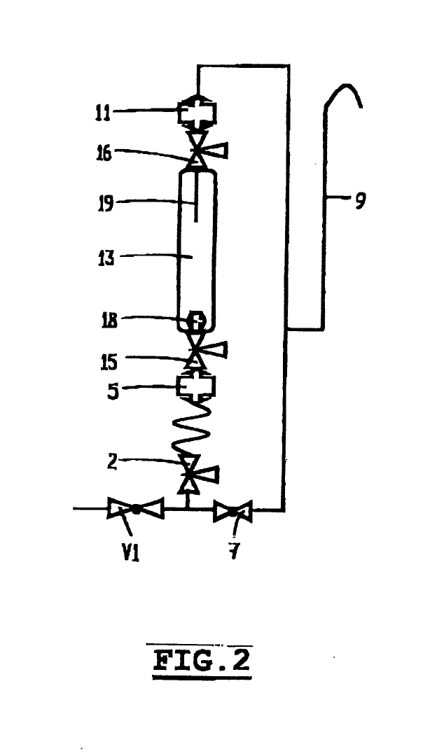

FIG. 2 shows a cross-section of a container for use in the apparatus according to FIG. 1.

FIG. 1 shows an apparatus according to the present invention comprising a panel 1, which is e.g. mounted on a tank lorry (not shown). The panel 1 is provided with a first valve 2, which is connected to a valve (V1; not shown) in the tank from which a sample is to be taken. It is preferred that the latter valve is mounted directly in the wall of the tank and is dedicated to the taking op samples. The first valve 2 is connected, via a pipe 3, to a T-piece 4, which is further connected to a quick connector 5 and, via a pipe 6, to a vent valve 7. The vent valve 7 is connected to a further T-piece 8, which in turn serves as or is connected to a vent 9 and is connected to a flexible pipe or hose 10. The flexible pipe 10 ends in a quick connector 11. The panel 1 is further provided with two clamps, i.e. a first clamp 12 for attaching a sampling container, such as a bottle 13, to the panel 1 and a second clamp 14 for attaching the quick connector 11 to the panel 1 when no sampling container 13 is present.

The sampling container 13 is provided with two valves, e.g. needle valve 15, 16, one on each end. The sampling container 13 can be of any suitable shape. Typically, it is a cylindrical container capable of withstanding the pressure of a liquefied gas at operating temperatures. If so desired, the bottle can be equipped with one or more handles 17 or carrying means in order to facilitate its transport.

As schematically shown in FIG. 2, the inlet valve 15 of the container 13 comprises a non-spray nozzle 18, which suppresses or even prevents the splashing of material through the container 13 and the associated build-up of static electricity. It is preferred that the non-spray nozzle 18 comprises an outlet opening which causes liquefied gas to enter the container 13 in a lateral direction. Thus, the nozzle 18 will become immersed as soon as a relatively small amount of liquefied gas has entered the container 13.

The outlet valve 16 of the container 13 is provided with a dip tube 19, which suppresses or even prevents over-filling of the container 13. Preferably, the length of the tube 19 is selected such that the container 13 can be filled with liquid up to 80% by volume, more preferably up to 60% by volume.

The quick connectors 5 and 11 are selected such that the container 13 can be attached to the panel 1 in just one way, i.e. with the non-spray nozzle 18 down, near the first valve 2, and dip tube 19 up and communicating directly with the flexible pipe 10. This can be ensured e.g. by mounting a female part of the quick connector at one end of the sampling bottle and a male part of the quick connector at the other end.

The vent 9 as presented in FIG. 1 can be any suitable vent. It can be a release to the atmosphere. However, if so desired, the gases can also be vented into a containment tank. Such contained gases can be liquefied if so desired. Alternatively, the vent can be directly connected to a pump. When such a pump is used, the (liquefied) gases are preferably pumped back to the tank from which the sample was taken.

The facilities to take samples from the tank container are preferably fixed to the said container. This will prevent contamination if the tank container is for dedicated storage of one flammable liquefied gas. More preferably, the connectors and valves are mounted on the container in such a way that transport is only possible when all valves are closed and quick connectors are secured.

A preferred method for taking samples using the system as described in FIG. 1 is a procedure containing the following steps:

1. locate the tank container near the unloading facilities, without any hose (such as the feed hose and vapour recovery hose) being connected,

2. connect a grounding cable between the tank container and the grounding point of the unloading facilities and check for the correct resistance to earth,

3. allow the tank container to stay untouched for at least 5 minutes to relax possible electrostatic charge retained on the container and its contents,

4. if necessary, ensured that valve V1 (in the tank wall) is closed,

5. take a suitable sampling bottle 13 (preferably empty),

6. fix the sampling bottle 13 to the sampling lines 3, 6, and 10 in accordance with FIG. 1 by first connecting connector 11, followed by connection of connector 5,

7. open valves 15, 2, and 7 to vent any remaining material, such as dimethyl ether, from the sampling bottle 13 and to make sure that the connection between the tank container and the sampling bottle 13 is empty and depressurised,

8. once empty, close all valves

9. open valve V1

10. open valve 16 (preferably ¼ to ½ a turn)

11. open valve 15 (preferably two turns)

12. fill the sampling bottle 13 by opening needle valve 2

13. keep an eye on the content in the vent line 9, which if necessary may be equipped with a mass flow meter and/or looking glass, to observe whether gaseous or liquid material, such as dimethyl ether, vents. A gaseous release is accompanied by an audible hissing sound. It is also slightly visible. A liquid release makes the sound of splashing. The droplets are clearly visible. The spray is sometimes white from condensing atmospheric moisture, but most often one will see a small spray of chilled droplets of material, such as dimethyl ether.

14. as soon as liquid dimethyl ether exits the vent line, close valve V1

15. close valve 16

16. close valve 15

17. open valve 7 to depressurise all sampling lines 3, 6, 10 between valve VI and the sampling bottle 13

18. close valve 2 and disconnect the sampling bottle 13.

The sampling bottle 13 can now be moved and sampling material can be dispensed from it in any suitable way.

The equipment and the procedure needed to take this sample ensure a low emission of the sampled material, e.g. dimethyl ether. The equipment and the procedure also reduce or prevent any risk of static electricity discharge as a possible source of ignition.

### EXAMPLE

Used was a sampling bottle 13 consisting of a 300 ml stainless steel vessel (type HOKE® 4HD300). The bottom of the vessel was provided with a SS316 ¼″ diameter needle valve 15 with a Non Spray Tube 18 (HOKE® 3752M4Y-NST) and a male TFE/SS304 ¼″ diameter Double Shut-Off quick connector 5 (HOKE® QCM4), while the top of the vessel was equipped with a ¼″ diameter needle valve 16 with a 60% fill level dip tube 19 (HOKE® 3752M4Y-DT60), followed by a female TFE/SS304 ¼″ diameter Double Shut-Off quick connector 11 (HOKE® QCF4). If so desired, the male and female quick connectors can be interchanged. The Non Spray entrance tube 18 in the bottom is a very small dip tube, which is blinded at the top. The material flows into the sampling bottle through slits on the side of this tube. This construction limits spraying and subsequent generation of static electricity charge. The top valve is fitted with a standard dip tube. This dip tube limits the fill level of the cylinder to approximately 60%.

This sampling bottle was hooked up to a tank in accordance with FIG. 1. The procedure as outlined above allowed sampling of dimethyl ether, (Demeon® D as supplied by Akzo Nobel) in a safe way and without excessive losses to the environment.

As a matter of course, the invention is not limited to the above-described embodiment and can be varied in numerous ways within the framework of the claims.

1. A sampling container for taking samples from a tank containing a flammable liquefied gas comprising an inlet opening and an outlet opening, at least two valves for operating the openings, a connector at the inlet opening for establishing fluid communication with the tank, and a nozzle which communicates with the inlet opening and which suppresses the splashing of liquefied gas flowing into the sampling container.

2. The sampling container according to claim 1, wherein the nozzle is blinded at its top end.

3. The sampling container according to claim 2, wherein the nozzle comprises one or more openings, preferably slits, in its side wall.

4. The sampling container according to any one of the preceding claims, wherein the outlet opening comprises a tube which extends inwards and which limits the amount of fluid that can enter the container.

5. The sampling container according to any one of claims 1 to 3, wherein the container is provided with a connector at both the inlet and the outlet opening and wherein these connectors are mutually different.

6. An apparatus for taking samples from a tank containing a flammable liquefied gas, comprising a first connector-counterpart for receiving the connector at the inlet opening of the sampling container according to any one of claims 1 to 3.

7. The apparatus according to claim 6, wherein the said connector-counterpart further communicates with a vent, preferably via a valve.

8. The apparatus according to claim 7 comprising a second connector-counterpart for receiving the connector at the outlet of the sampling container.

9. The apparatus according to claim 8, wherein the second connector-counterpart also communicates with the vent.
